(19) United States
(12) Patent Application Publication
(10) Pub. No.: US 2009/0206787 A1
(43) Pub. Date: Aug. 20, 2009

(54) Drive Control System and Machine Control Device

(75) Inventor: Itsuo Seki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION, Chiyoda-ku, Tokyo (JP)

(21) Appl. No.: 11/794,613

(22) PCT Filed: Mar. 7, 2005
(86) PCT No.: PCT/JP2005/003894

§ 371 Date: Jul. 3, 2007

(51) Int. Cl. G05B 11/32

(52) U.S. Cl. 318/562

(57) ABSTRACT

A drive control system includes a drive control device, an auxiliary control device, and a physical-amount detecting device. The physical-amount detecting device detects a physical amount such as position information necessary for the machine control device to operate. The drive control device, the auxiliary control device, and the physical-amount detecting device are connected to each other with a data communication line. Physical amount detected by the physical-amount detecting device is directly transmitted synchronously in a constant cycle to one or both of the drive control device and an auxiliary control device through the data communication line.

### TECHNICAL FIELD

The present invention relates to a drive control system and a machine control device that is an important part of a drive control system that are used for a numerical control device and a robot, a semiconductor manufacturing device, and a mounting device of an electronic device.

### BACKGROUND ART

FIG. 8 is a block diagram of a configuration example of a conventional drive control system. FIG. 8 depicts a servo motor drive control system disclosed in Patent Document 1. As shown in FIG. 8, a numerical control device 50 is connected to two drive control devices 51 and 52 through communication lines 55 and 56. The numerical control device 50 operates as an instructing device. The two drive control devices 51 and 52 mutually synchronously operate as a master device and a slave device. In the example shown in FIG. 8, the drive control device 51 operates as a master, and the drive control device 52 operates as a slave.

A communication line 55 connected to a transmitting unit 60 of the numerical control device 50 is a downlink communication line, and a communication line 56 connected to a receiving unit 61 of the numerical control device 50 is an uplink communication line. The drive control device 51 includes a receiving unit 62 and a transmitting unit 63 connected to the downlink communication line 55, and a transmitting unit 64 and a receiving unit 65 connected to the uplink communication line 56. On the other hand, the drive control device 52 includes a receiving unit 66 connected to the downlink communication line 55, and a transmitting unit 67 connected to the uplink communication line 56.

The drive control device 51 is connected to a servomotor 82, and to an encoder 83 fitted to an end of a rotation axis of the servo motor 82. The drive control device 52 is connected to a servomotor 85, and to an encoder 86 fitted to an end of a rotation axis of the servomotor 85. The drive control devices 51 and 52 acquire control results about the servomotors 82 and 85 from the outputs of the encoders 83 and 86.

A table 88 of a machine tool or the like has ball screws 89 and 90. Those ball screws 89 and 90 can be used for controlling the movement or position of the table 88. The ball screw 89 is coupled to the rotation axis of the servomotor 82, and the ball screw 90 is coupled to the rotation axis of the servomotor 85.

In the drive control system shown in FIG. 8, the numerical control device 50 issues instructions to the two drive control devices 51 and 52. Based on these instructions, the two drive control devices 51 and 52 drive control the servomotors 82 and 85 to control the position or movement of the table 88.

The outline of the control operation is explained below. A communication cycle of the drive control devices 51 and 52 is 1/n (where n is an integer, and n=2 in the current example) of a communication cycle of the numerical control device 50. In the example of FIG. 8, the numerical control device 50 transmits a control instruction from the transmitting unit 60 to the downlink communication line 55 at each of its own control cycle.

The drive control device 51 controls the servomotor 82 based on a control instruction received by the receiving unit 62 from the numerical control device 50, and detection data received from the encoder 83. The drive control device 52 controls the servomotor 85 based on a control instruction received by the receiving unit 66 from the numerical control device 50 and detection data received from the encoder 86. The servomotors 82 and 85 drive the ball screws 89 and 90, so that the table 88, which is sitting on the ball screws 89 and 90, is moved to a position indicated in the control instructions.

The drive control device 52 transmits diagnostic data and detection data from the transmitting unit 67 to the uplink communication line 56. The diagnostic data is information such as current state, warning, and alarm. The detection data is information such as position, speed, and current detected at the time of controlling the servomotor 85. Because the drive control device 51 is disposed on the upstream of the drive control device 52, the diagnostic data and the detection data transmitted by the drive control device 52 to the uplink communication line 56 are received by the receiving unit 65 of the drive control device 51 directly, i.e., without passing through the numerical control device 50.

The drive control device 51 compares the detection data received by the receiving unit 65 with its own detection data and calculates a synchronization error based on the comparison. The drive control device 51 generates a synchronization-error-correction control instruction based on the calculated synchronization error, and transmits this instruction via the transmitting unit 63 and the downlink communication line 55 to the drive control device 52.

The receiving unit 66 of the drive control device are directly input to the image recognizing device having the pulse generation function, to carry out the shutter control of the camera 105, imaging, and image recognition.

Patent Document 1: Patent Republication No. 2002-52715

### DISCLOSURE OF INVENTION

### Problem to be Solved by the Invention

FIG. 10 is an explanatory diagram of the position control operation of the table 106 shown in FIG. 9. In the stop position control, a generation timing of the shutter pulse 122 is important. In other words, when the shutter pulse 122 can be correctly generated at an assigned position, as shown in FIG. 10(a), the workpiece 110 can be imaged within an imaging area 111, thereby correctly recognizing the position of the workpiece 110.

However, in the configuration shown in FIG. 9, a deviation occurs in the generation timing of the shutter pulse 122 due to which the workpiece 110 partially goes out of the imaging area 111, as shown in FIG. 10(b). Accordingly, the position of the workpiece 110 cannot be correctly recognized, and the workpiece 110 cannot be positioned by the positioning line 112. This is explained in detail below.

In other words, in the configuration shown in FIG. 9, the encoder 109₁ corresponds to the drive control device 102₁, and the encoder 109₂ corresponds to the drive control device 102₂. In this way, the drive control device and the encoder correspond to each other in one-to-one relationship. Position information detected by the encoder is transmitted to other drive control device and the instruction control device, after once passing through the corresponding drive control device, and is also transmitted to the pulse generating device and the image recognizing device.

52 receives the synchronization-error-correction control instruction transmitted to the downlink communication line 55. The drive control device 52 drive controls the servomotor 85 to correct the instructed synchronization error.

Because of the difference in the communication cycles, during the time the numerical control device 50 transmits a control instruction once to the downlink communication line 55, the drive control device 52 transmits diagnostic data and detection data twice to the drive control device 51 via the uplink communication line 56, and the drive control device 51 transmits the synchronization-error-correction control instruction twice to the drive control device 52 via the downlink communication line 55.

As explained above, in the drive control system shown in FIG. 8, it is possible to transmit at high speed the synchronization-error-correction control instruction from the drive control device 51 to the drive control device 52 without being constrained by the control cycle of the numerical control device 50.

The position of a workpiece mounted on the table dynamically may change due to the environmental conditions. Therefore, it is necessary to correct the position instruction according to the current position of the workpiece, and it also is necessary to change the target position according to changes in the environmental conditions. It is possible to configure a drive control system that accurately carries out the position control of the table by performing image recognition on an image of the workpiece with an image recognizing device, as shown in FIG. 9, using the conventional drive control system.

FIG. 9 is a block diagram of a configuration example of the drive control system according to the conventional technique. This drive control system includes an image recognizing device in addition to the conventional drive control system shown in FIG. 8. In FIG. 9, reference numerals of the constituent elements are changed from those in FIG. 8. As shown in FIG. 9, an overall control device 100, a pulse generating device 103 and an image recognizing device 104 that are connected to the overall control device 100, and a camera 105 attached to the image recognizing device 104 are provided, as well as an instruction control device 101, substituting for the numerical control device 50, in the drive control system shown in FIG. 8. A workpiece 110 is shown on a table 106. Reference numeral 111 attached to box drawn with a broken line denotes an imaging area of the camera 105.

The instruction control device 101 is equivalent to the numerical control device 50 shown in FIG. 8, and has the name different from the numerical control device, to clarify that the instruction control device 101 generates a position instruction. The overall control device 100 is new provided and it has a function to arrange correction position data by the image process and to set and change parameters of the instruction control device 101.

Specifically, the overall control device 100 sets parameters to the instruction control device 101 at the starting time of the control operation. The overall control device 100 also receives information about control results from the pulse generating device 103 and the image recognizing device 104, and sets parameters to the instruction control device 101.

Further, the instruction control device 101 transmits position instruction data 115 to drive control devices 102₁ and 102₂. Encoders 109₁ and 109₂ detect pulse and carries out the image control of the camera.

The above explains the following operation. During the move of the table 106 to a stop position set in advance, the image recognizing device 5 recognizes the position of the workpiece 110 from the image within an image area 111 picked up by the camera 105, and directly gives this position information to the instruction control device 2. The instruction control device 2 calculates a correction instruction from the position information of the workpiece 110, and transmits the correction position to the drive control devices 3₁ and 3₂. The operation is repeated in each communication cycle. With this arrangement, the drive control devices 3₁ and 3₂ drive control the motors 108₁ and 108₂ to rotate the ball screws 107₁ and 107₂, and move the table 106 until when the right end of the workpiece 110 reaches the line 112.

As can be understood from the operation example, the positioning control considering a series of positional correction achieved in the first embodiment can be executed, using only the machine control device 9 containing the instruction control device 2 and the physical-amount detecting device 11, and the first data-communication line group 8 and the second data-communication line group 10, without presence of the overall control device 1.

In this case, the communication speed of the second data-communication line group 10 is set faster than the communication speed of the first data-communication line group 8, and the physical-amount detecting device 11 detects and transmits a physical amount in a higher frequency than that of the control information such as a position instruction for controlling the machine control device 9. Therefore, a positioning control considering the series of positional correction can be carried out in high current positions of servomotors 108₁ and 108₂, and transmit these pieces of information as feedback-position instruction data 118 and 119, to the drive control devices 102₁ and 102₂. The drive control devices 102₁ and 102₂ transmit state data 116 of diagnostic data to the instruction control device 101.

The drive control devices 102₁ and 102₂ convert the feedback-position instruction data 118 and 119 received from the encoders 109₁ and 109₂ into feedback pulses 120 and 121 including pulse string signals, and output the feedback pulses 120 and 121 to the pulse generating device 103 and the image recognizing device 104.

The pulse generating device 103 and the image recognizing device 104 count the number of pulses of the feedback pulses 120, 121 to recognize the current positions of the current positions of servomotors 108₁ and 108₂, and carry out a predetermined operation based on the recognition.

In other words, the pulse generating device 103 counts the number of pulses of the feedback pulses 120, 121. When the count becomes a certain set value, the pulse generating device 103 generates a trigger pulse of the camera 105 attached to the image recognizing device 104 and a shutter pulse 122 of an illuminating device not shown, and gives the trigger pulse to the image recognizing device 104.

In the example shown in FIG. 9, the servomotors 108₁ and 108₂ rotate ball screws 107₁ and 107₂, and moves the table 106 to a horizontal direction. When the table is moved to an appropriate imaging point, the pulse generating device 103 generates a shutter pulse 122 to image the workpiece 110 on the table 106 with the camera 105.

The image recognizing device 104 carries out an instruction control device and the corrected-position instruction data needs to be transmitted to the drive control device, before the table reaches the positioning line. However, this operation is difficult in the example.

Further, when the number of each of the drive control device, the image recognizing device, and the pulse generating device increases, the amount of data that can be transmitted to the communication line and the transmission speed reach the upper limit, because the communication cycle and the communication line are fixed, even if each of the drive control device, the image recognizing device, and the pulse generating device has its own processing capacity. Consequently, the instruction control device cannot transmit position instruction data and state data to all the drive control devices within the time of the communication cycle.

In addition, when the rotation number of the servomotor increases, the frequency of the feedback pulse to the image recognizing device and the pulse generating device increases. Therefore, the quality of the pulse decreases, and there is influence of noise. Accordingly, the rotation number of the servomotor needs to be limited, and the transmission distance needs to be decreased.

In summary, the information of the encoder that generates a shutter pulse needs to be all transmitted to the pulse generating device at high speed. The drive control device needs to take in at high speed not only the information of the encoder of the own device but also the information of other encoder, and needs to carry out the positioning control by considering a difference of positions and variations in characteristics. For this purpose, detection information of a physical-amount detecting device such as an encoder needs to be directly image processing of the imaged data of the workpiece 110 imaged by the camera 105, thereby recognizing the position of the workpiece 110. In the example shown in FIG. 9, a positioning line 112 is set in advance as a stop point of the table 106. When the right end of the workpiece 110 reaches the positioning line 112, the image data of the workpiece 110 imaged by the camera 105 is used for the recognition data of the stop position, to stop the table 106.

The control of stopping the table 106 based on the position of the workpiece 110 can be realized as follows. In the process that the drive control devices 102 and 102₂ move the table 106 to the preset stop position, the image recognizing device 104 gives the shutter pulse to the camera 105, and transmits the position information of the workpiece 110 recognized by the image data of the workpiece 110 imaged by the camera 105 to the overall control device 100. The overall control device 100 gives the received position information to the instruction control device 101.

The instruction control device 101 calculates position instruction data 115 obtained by correcting the stop position based on the position information, and transmits the position instruction data 115 to the drive control devices 102₁ and 102₂. With this arrangement, the drive control devices 102₁ and 102₂ drive control the servomotors 108₁ and 108₂ to rotate the ball screws 107₁ and 107₂, and move the table 106 until when the right end of the workpiece 110 reaches the positioning line 112.

While the pulse generating device 103 is separated from the image recognizing device 104 in FIG. 9, the image recognizing device can have a pulse generation function. In this case, the feedback pulses 120 and 121 Therefore, there occurs a delay in each drive control device during a period from when the corresponding encoder inputs feedback position data until when the drive control device outputs the feedback pulse. As a result, a delay occurs in the shutter timing to pick up an image, in the image processing device and the pulse generating device, and the image cannot be taken in at the assigned position.

While the table is simultaneously driven by the two-axis ball screws in FIG. 9, to control plural axes in coordination, each derive control device needs to position control each servomotor in the same manner regardless of variations in the characteristics of the individual servomotors. For this purpose, position information of other drive axis is instantly necessary. However, in the configuration shown in FIG. 9, position information of the encoder of other drive shaft is taken in by corresponding other drive control device, and is transmitted to the own drive control device via the communication line. Therefore, a transmission delay that cannot be disregarded occurs in the position information of the encoder of the obtained other drive shaft, and correct coordination control cannot be achieved.

Furthermore, the overall control device manages the instruction control device, the image recognizing device, and the pulse generating device. Because various kinds of information are always exchanged via the overall control device, the load of the overall control device increases. Therefore, the overall control device cannot instantly control at high speed the feedback of the correction position recognized by the image recognizing device. In the example shown in FIG. 10(b), the position information of the workpiece recognized by the image recognizing device needs to be transmitted to the transmitted, as communication data, to other drive control device, the pulse generating device, the image recognizing device, and the instruction control device via the communication line, without via the drive control device. With this arrangement, a transmission delay generated due to the passing through the drive control device needs to be decreased.

Not only information from the encoders to the physical-amount detecting device, but also the drive control device, and the pulse generating device, instruction information between higher control devices such as the image recognizing device, the overall control device, the instruction control device, and the drive control device needs to be transmitted efficiently at high speed. Therefore, for this purpose, information necessary for the drive control such as position instruction information and feedback position information needs to be transmitted efficiently at high speed between the overall control device, the instruction control device, the drive control device, the image recognizing device, the pulse generating device and the physical-amount detecting device such as an encoder.

However, in taking the measure described above, when the communication speed of each device such as an encoder increases and the number of devices (the number of motors) increases along the increase of the speed of drive control and increase of the number of axes, a set of data communication lines requires high-speed communication of feedback position information. Therefore, a substantial increase of communication speed of the data communication lines becomes necessary. As a result, communication quality of high-speed communication needs to be secured, and this results in cost increase.

Furthermore, the communication speed between the instruction control device and the drive control device can be slower than the communication speed between the drive control device and the physical-amount detecting device such as the encoder. Therefore, all communication lines do not need to be uniformly set to the same communication speed (cycle). The communication line between the devices in the drive control system is fixed, and there is limit to the communication line depending on the type of devices and processing content.

On the other hand, according to the drive control system disclosed in the Patent Document 1, two kinds of communication lines of the data transmitting communication line and the data receiving communication line are configured for the instruction control device, between the devices. Data communication is carried out in a constant communication cycle in these data communication lines. According to this communication cycle, when the number of devices (the number of motors) exceeds the capacity capable of handling data amount, the devices cannot carry out communication. Therefore, communication lines between the devices need to be built up from a new viewpoint.

To achieve the measure, a physical-amount detecting device such as an encoder, a limit switch, and an acceleration sensor needs to be able to communicate with other devices, not only to communicate with corresponding devices. However, according to the drive control system disclosed in the Patent Document 1, the physical-amount detecting device such as an encoder, a limit switch, and an acceleration sensor is configured to communicate with only the corresponding devices, and is not configured to directly communicate with other devices. Therefore, communication lines need to be built up from a new viewpoint.

The present invention has been achieved in view of the above problems, and it is an object of the present invention to obtain a drive control system and a machine control device capable of efficiently transmitting at high speed detection information of a physical-amount detecting device such as an encoder, with minimum transmission delay.

It is another object of the present invention to obtain an efficient drive control system and an efficient machine control device capable of decreasing the load of an overall control device.

It is still another object of the present invention to obtain a drive control system and a machine control device capable of transmitting information at high speed by decreasing the influence of noise, even when devices are disposed at a long distance from each other.

### Means for Solving Problem

To achieve the above objects, according to an aspect of the present invention; a drive control system includes an instruction control device that generates an instruction for drive controlling a motor which controls a drive shaft of an object to be controlled, a physical-amount detecting device that detects a physical amount such as position information and speed information of the controlled object changed by the drive shaft controlled by the motor, and a drive control device that generates a drive control signal to the motor based on the instruction generated by the instruction control device and the physical amount detected by the physical-amount detecting device. A data communication line is provided to connect between the physical-amount detecting device and the drive control device in parallel. The physical-amount detecting device converts detected physical amount into a communication data format, and transmits the communication data to the data communication line following a communication cycle prescribed by the data communication line, and the drive control device receives the physical amount data from the data communication line, following the communication cycle prescribed by the data communication line.

According to the present invention, the physical-amount detecting device such as an encoder can transmit detection information to the drive control device efficiently and at high speed, with minimum transmission delay.

### EFFECT OF THE INVENTION

The present invention has an effect of obtaining a drive control system capable of efficiently transmitting at high speed detection information of a physical-amount detecting device such as an encoder, with minimum transmission delay.

### BRIEF DESCRIPTION OF DRAWINGS

FIG. 1 is a block diagram of a configuration of a drive control system according to a first embodiment of the present invention.

FIG. 2 is a time chart for explaining a process in which a machine control device and a physical-amount detecting device shown in FIG. 1 achieve a control operation by exchanging communication data via data communication lines.

FIG. 3 is a block diagram of a configuration of a drive control system according to a second embodiment of the present invention.

FIG. 4 is a time chart for explaining an operation of communication data exchanges via data communication lines carried out by a machine control device and a physical-amount detecting device shown in FIG. 3.

FIG. 5 is a block diagram of a configuration of a drive control system according to a third embodiment of the present invention.

FIG. 6 is a time chart for explaining an operation of communication data exchanges via data communication lines carried out by a machine control device and a physical-amount detecting device shown in FIG. 5.

FIG. 7 is a block diagram of a configuration of a machine control device according to a fourth embodiment of the present invention.

FIG. 8 is a block diagram of a configuration example of a conventional drive control system.

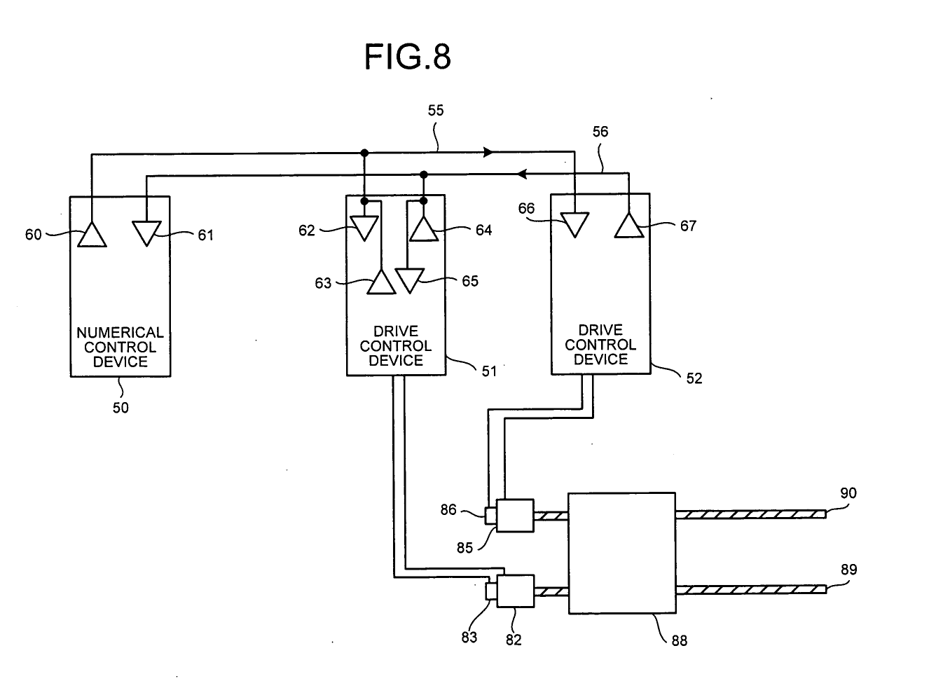

FIG. 9 is a block diagram of a configuration example of a drive control system according to a conventional technique to build an image recognizing device in the conventional drive control system shown in FIG. 8.

FIG. 10 is an explanatory diagram of a position control operation of a table shown in FIG. 9.

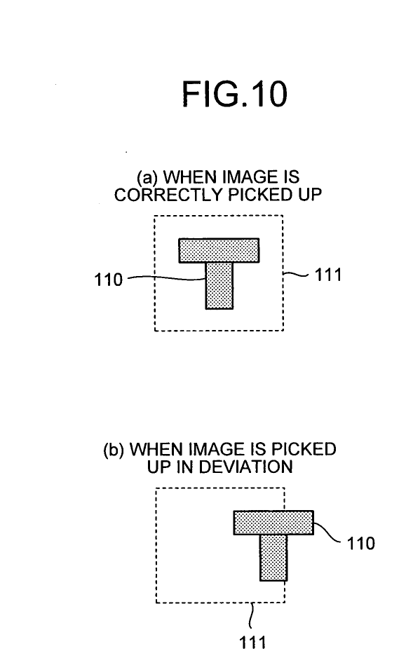

### EXPLANATIONS OF LETTERS OR NUMERALS

1 Overall control device
2, 20 Instruction control device
3₁, 3₂, 21₁, 21₂, 21₃ Drive control device
4 Pulse generating device
5 Image recognizing device
6₁, 6₂ Encoder
8 First data-communication line group
8₁, 8₂, 8₃, 8₄ to 8ₘ First data-communication line
9 Machine control device
10 Second data-communication line group
10₁, 10₂, 10₃, 10₄ to 10ₙ Second data-communication line
11, 11₁, 11₂, 11₃, 11₄ Physical-amount detecting device
12a, 12b, 12c, 12d, 12e Transmitting unit
13a, 13b, 13c, 13d, 13e Receiving unit
105 Camera
106 Table
107₁, 107₂ Ball screw
108₁, 108₂ Servomotor
110 Workpiece
111 Image area
112 Positioning line
23a, 23b, 23c, 23d, 23e, 23f, 23g, 23h Transmitting and receiving unit
24a, 24b, 24c, 24d, 24e, 24f, 24g, 24h Transmitting and receiving unit
25a, 25b, 25c, 25d, 25e, 25f, 25g, 25h Transmitting and receiving unit
26a, 26b, 26c, 26d, 26e, 26f, 26g, 26h Transmitting and receiving unit
27a, 27b, 27c Transmitting and receiving unit
30 Transmitting and receiving unit to first data-communication line group
31 Processing main unit
32 Transmitting and receiving unit to second data-communication line group
33₁ to 33ₘ, 36₁ to 36ₙ Transmission buffer
34₁ to 34ₘ, 35₁ to 35ₙ Receiving buffer

### BEST MODE(S) FOR CARRYING OUT THE INVENTION

Exemplary embodiments of a drive control system and a machine control device according to the present invention will be explained below in detail with reference to the accompanying drawings.

### First Embodiment

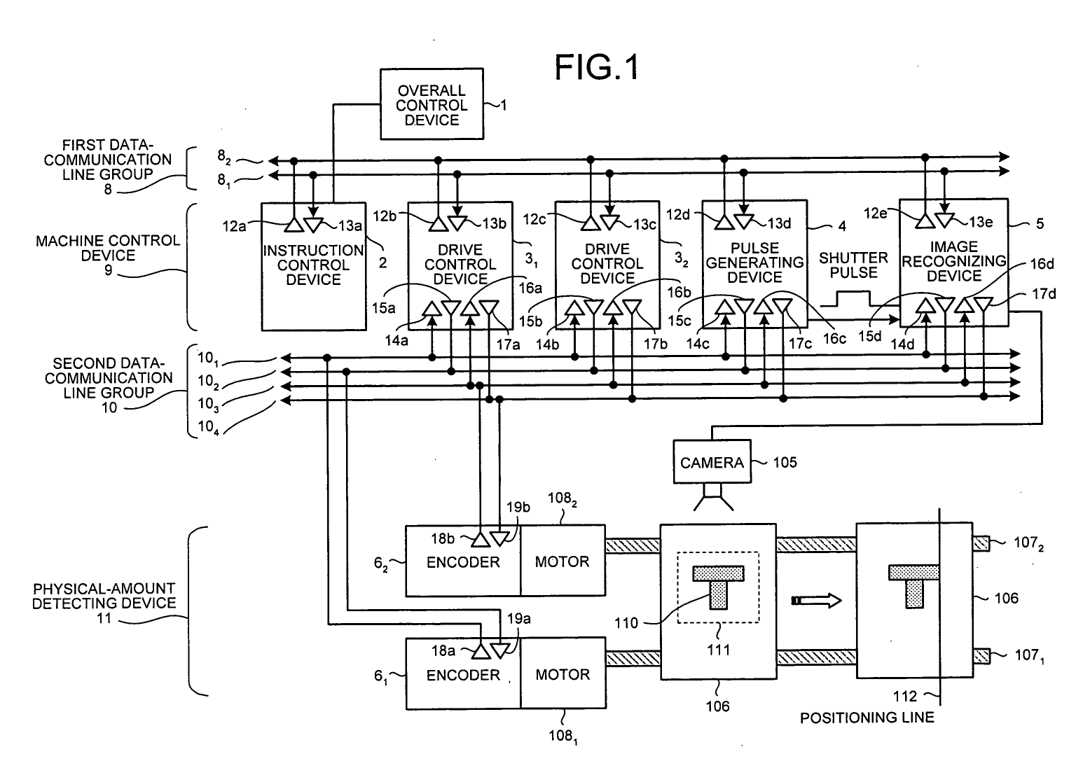

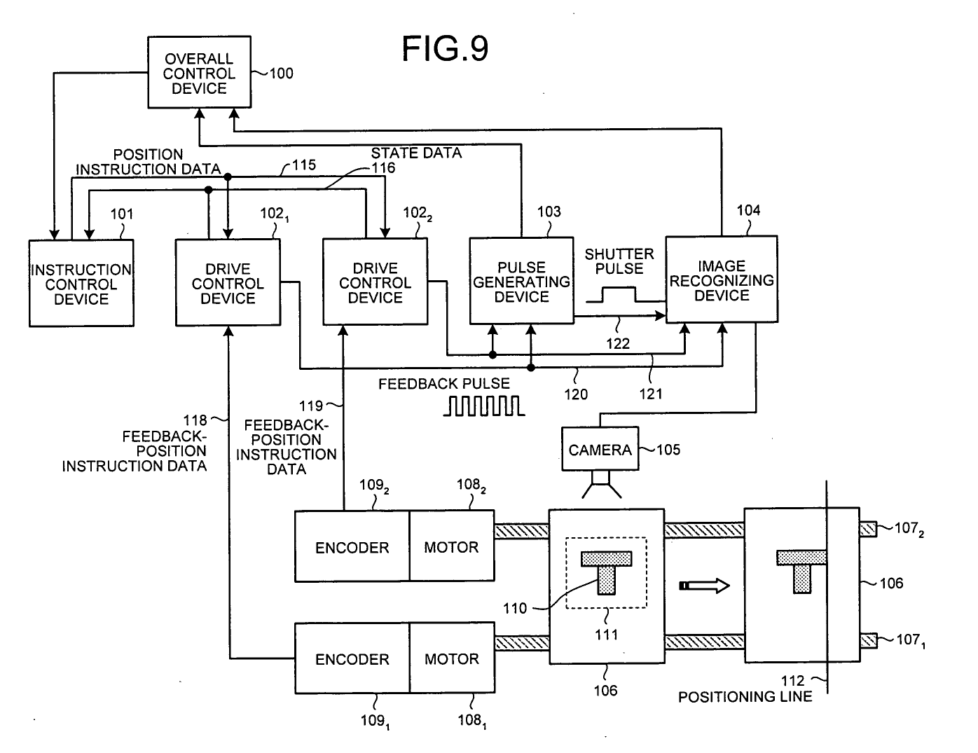

FIG. 1 is a block diagram of a configuration of a drive control system according to a first embodiment of the present invention. FIG. 1 is a configuration example of a drive control system built in with an image recognizing device, to facilitate the understanding of the present invention, like in the conventional example (FIG. 9). Therefore, in FIG. 1, constituent elements identical with or equivalent to those shown in FIG. 9 are denoted with like reference numerals. An overall control device 1, an instruction control device 2, drive control devices 3₁ and 3₂, a pulse generating device 4, an image recognizing device 5, and encoders 6₁ and 6₂ denoted with different reference numerals from those in FIG. 9 are similar to those shown in FIG. 9 in their main functions, but are different in communication modes between devices. In FIG. 1, a connection line present between the drive control device 3₁ and the servomotor 108₁, and a connection line present between the drive control device 3₂ and the servomotor 108₂ are omitted.

In the present specification, main devices that constitute the drive control system, such as the instruction control device 2, the drive control devices 3₁ and 3₂, the pulse generating device 4, and the image recognizing device 5, are simply called a “machine control device”, except where these devices are required to be specifically called separately. In FIG. 1, these devices are collectively called a machine control device 9. In FIG. 1, only the encoders 6₁ and 6₂ are shown as position sensors from a viewpoint that the driving system shown in the conventional example (FIG. 9) is configured from a different viewpoint. However, in general, the driving system also uses a speed sensor, a torque sensor, and a temperature sensor. Because these devices detect a physical amount necessary for the machine control device to operate, these devices are also simply called a “physical-amount detecting device”, except where these devices are required to be specifically called separately. In FIG. 1, the encoders 6₁ and 6₂ are collectively called a physical-amount detecting device 11. When the devices are called the physical-amount detecting device 11, a speed sensor not shown is also included in this physical-amount detecting device.

The pulse generating device 4 and the image recognizing device 5 are positioned as auxiliary devices that support the overall drive control. Therefore, the pulse generating device 4 and the image recognizing device 5 are simply collectively called an “auxiliary control device”, except where these devices are required to be specifically called separately. However, the pulse generating device 4 and the image recognizing device 5 are one example of the auxiliary control device. When the drive control system is a robot system, a visual sensor (an image recognizing device) of the robot is the auxiliary control device. In other words, in the present invention, the auxiliary control device is an auxiliary device that processes physical amount data detected by various kinds of physical-amount detecting devices into feedback information to the instruction control device, to achieve drive control at high speed, flexibly, and in high precision.

Unlike in the conventional example (FIG. 9), the overall control device 1 communicates with only the instruction control device as shown in FIG. 1. The instruction control device 2, the drive control devices 3₁ and 3₂, the pulse generating device 4, and the image recognizing device 5 exchange communication data of a predetermined format via a first data-communication line group 8 including two data communication lines 8₁ and 8₂.

Specifically, the communication data output from a transmitting unit 12a of the instruction control device 2 is taken into receiving units 13b, 13c, 13d, and 13e of the drive control devices 3₁ and 3₂, the pulse generating device 4, and the image recognizing device 5, respectively, via the first data-communication line group 8₁. The communication data output from transmitting units 12b, 12c, 12d, 12e of the drive control devices 3₁ and 3₂, the pulse generating device 4, and the image recognizing device 5, respectively are taken into a receiving unit 13a of the instruction control device 2, via the first data-communication line 8₂.

The drive, control devices 3₁ and 3₂, the pulse generating device 4, and the image recognizing device 5, and the encoders 6₁, excluding the instruction control device 2, out of the machine control device 9, and the encoders 6₁ and 6₂ as the physical-amount detecting device 11 can exchange communication data of a predetermined form to each other, via a second data-communication line group 10 including four data communication lines 10₁, 10₂, 10₃, and 10₄, respectively.

Specifically, the communication data output from a transmitting unit 18a of the encoder 6₁ is taken into receiving units 14a, 14b, 14c, and 14d of the drive control devices 3₁ and 3₂, the pulse generating device 4, and the image recognizing device 5, respectively, via the second data-communication line group 10₁. The communication data output from transmitting units 15a, 15b, 15c, 14d of the drive control devices 3₁ and 3₂, the pulse generating device 4, and the image recognizing device 5, respectively are taken into a receiving unit 19a of the encoder 6₁, via the second data-communication line 10₂.

The communication data output from a transmitting unit 18b of the encoder 6₂ is taken into receiving units 16a, 16b, 16c, and 16d of the drive control devices 3₁ and 3₂, the pulse generating device 4, and the image recognizing device 5, respectively, via the second data-communication line group 10₃. The communication data output from transmitting units 17a, 17b, 17c, and 17d of the drive control devices 3₁ and 3₂, the pulse generating device 4, and the image recognizing device 5, respectively are taken into a receiving unit 19b of the encoder 6₂, via the second data-communication line 10₄.

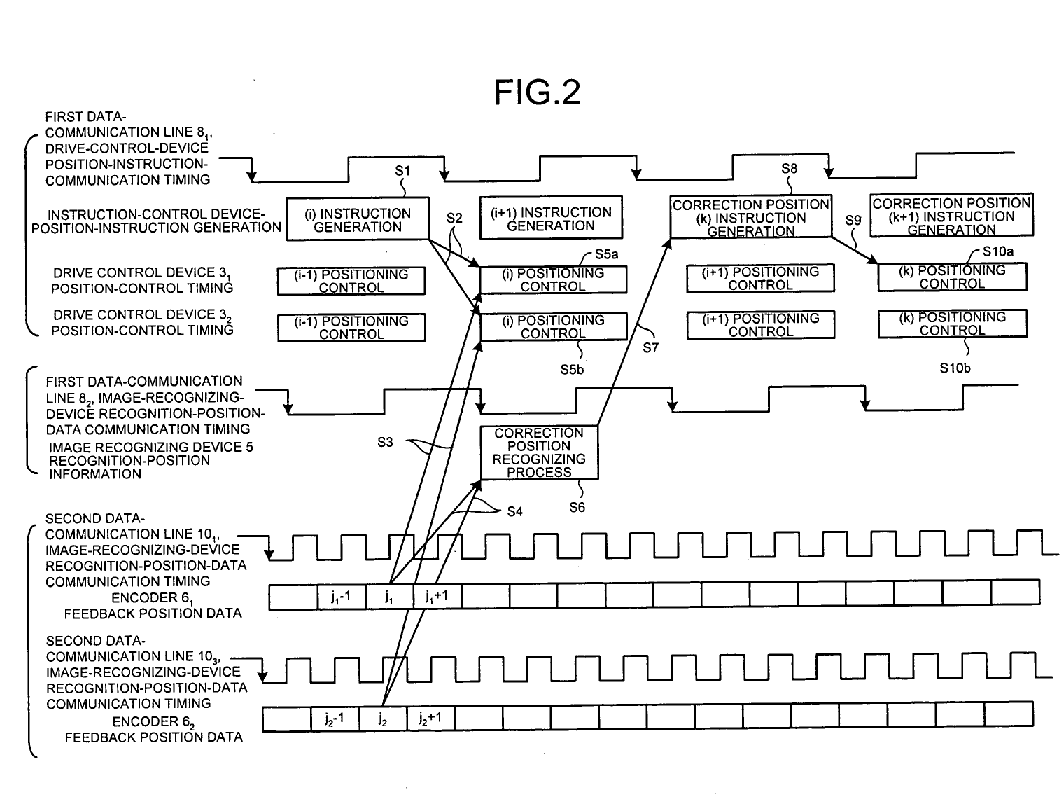

The control operation of the drive control system shown in FIG. 1 is explained next with reference to FIG. 1 and FIG. 2. FIG. 2 is a time chart for explaining the process in which the machine control device and the physical-amount detecting device shown in FIG. 1 achieve the control operation by exchanging the communication data via the data communication lines.

As shown in FIG. 2, the communication cycle of the second communication line group 10 (hereinafter, also “second communication cycle”) is shorter than the communication cycle of the first data-communication line group 8 (hereinafter, also “first communication cycle”). In the generation timing of the communication cycle in the first data-communication line group 8, the phase of the first data-communication line 8₁ is advanced from the phase of the first data-communication line 8₂. In the generation timing of the communication cycle in the second data-communication line group 10, the phase of the second data-communication line 10₁ is the same as the phase of the second data-communication line 10₃. However, the phase of the second data-communication line 10₁ is advanced from the phase of the second data-communication line 10₂, and the phase of the second data-communication line 10₃ is advanced from the phase of the second data-communication line 10₄.

In FIG. 1, the overall control device 1 sets and instructs parameters to the instruction control device 2 at the starting time of the control operation. The instruction control device 2 first generates a position instruction following the setting and the instruction from the overall control device 1, and transmits communication data of a predetermined format, having the position instruction as content and the drive control devices 3₁ and 3₂ as destinations, to the first data-communication line 8₁ in each communication cycle in synchronism with the communication cycle.

In FIG. 2, a (i) instruction and a (i+1) instruction are sequentially transmitted to the first data-communication line 8₁. The (i) instruction (S2) that the instruction control device 2 generates and transmits is explained. The (i) instruction (S1) is taken into the drive control devices 3₁ and 3₂ in the same communication cycle (S2).

On the other hand, the encoders 6₁ and 6₂ detect feedback positions of the servomotors 108₁ and 108₂. The encoder 6₁ transmits the detected feedback position data to the second data-communication line 10₁ in synchronism with the second cycle, and the encoder 6₂ transmits the detected feedback position data to the second data-communication line 10₃ in synchronism with the second cycle. Because the second communication cycle is shorter than the first communication cycle, the encoders 6₁ and 6₂ transmit plural feedback position data within the period of the first communication cycle.

In this case, the encoders 6₁ and 6₂ simultaneously transmit the feedback position data of the same content, that is, the feedback position data having the drive control devices 3₁ and 3₂ as destinations, and the feedback position data having the pulse generating device 4 and the image recognizing device 5 as destination.

In FIG. 2, near the communication cycle in which the instruction control device 2 generates and transmits the instruction (S1), the encoder 6₁ simultaneously transmits feedback position data “j₁−1”, “j₁”, and “j₁₊₁”, that is, feedback position data (S3) having the drive control devices 3₁ and 3₂ as destinations, and feedback position data (S4) having the pulse generating device 4 and the image recognizing device 5 as destinations, to the second data-communication line 10₁.

The encoder 6₂ simultaneously-transmits feedback position data “j₂−1”, “j₂” and “j₂+1”, that is, feedback position data (S3) having the drive control devices 3₁ and 3₂ as destinations, and feedback position data (S4) having the pulse generating device 4 and the image recognizing device 5 as destinations, to the second data-communication line 10₃.

Therefore, the drive control devices 3₁ and 3₂ can take in the feedback position data (S3) of the servomotors 108₁ and 108₂ that the encoders 6₁ and 6₂ detect and generate, in the same communication cycle as that in which the instruction control device 2 generates and transmits the (i) instruction (S1).

The drive control devices 3₁ and 3₂ simultaneously execute positioning controls (S5a), (S5b) based on the (i) instruction (S1), in the next communication cycle of the first data communication cycle in which the instruction control device 2 generates and transmits the (i) instruction (S1). In this case, the feedback position data (S3) of the servomotors 108₁ and 108₂ that the encoders 6₁ and 6₂ detect and generate can be reflected in the positioning control to be executed.

This is explained in detail below. In FIG. 1, the table 106 is simultaneously driven by the two-axis ball screws 107₁ and 107₂. Therefore, the drive control devices 3₁ and 3₂ can carry out the positioning control of the servomotors 108₁ and 108₂ in the same manner, regardless of variations in the characteristics of the servomotors 108₁ and 108₂. For this purpose, the drive control devices 3₁ and 3₂ need to fetch not only the information of the encoders for the own device but also the information of encoders for other devices, and carry out the positioning control by considering a difference of positions and variations in characteristics.

In this respect, according to the first embodiment, as described above, the drive control devices 3₁ and 3₂ can take in the feedback position data (S3) of the servomotors 108₁ and 108₂ that the encoders 6₁ and 6₂ detect and generate, in the same communication cycle as that in which the instruction control device 2 generates and transmits the (i) instruction (S1). Therefore, the drive control device 3₁ can simultaneously obtain the information of the encoder 6₂ as well as the information of the encoder 6₁. The drive control device 3₂ can also operate in the similar manner.

Therefore, the drive control devices 3₁ and 3₂ can carry out the positioning control by considering the difference of control positions of the mutual servomotors and variations in characteristics. Because the encoders 6₁, 6₂ input feedback position data of each servomotor in high frequency, the drive control devices 3₁ and 3₂ can carry out the positioning control in high precision.

The pulse generating device 4 and the image recognizing device 5 can take in the feedback position data (S4) of the servomotors 108₁ and 108₂ that the encoders 6₁ and 6₂ detect and generate, in the same communication cycle as that in which the instruction control device 2 generates and transmits the (i) instruction (S1).

Therefore, the pulse generating device 4 and the image recognizing device 5 can control the camera 105 using the feedback position data (S4) of the servomotors 108₁ and 108₂ obtained from the encoders 6₁ and 6₂, to execute a correction position recognition process (S6) from the picked-up image of the workpiece 110, without a delay, in the first communication cycle as that in which the drive control devices 3₁ and 3₂ simultaneously carry out positioning controls (S5a), (S5b).

The operation is specifically explained below. The pulse generating device 4 monitors the feedback position data (S4), and generates a trigger pulse such as a shutter pulse of the camera 105 and an illuminating device attached to the image recognizing device 5 at a certain set value. In the example shown in FIG. 1, the drive control devices 3₁ and 3₂ move the table 106 horizontally by rotating the ball screws 107₁ and 107₂ with the servomotors 108₁ and 108₂. When the table 106 moves to a proper imaging point, the pulse generating device 4 generates a shutter pulse for the camera 105 to image the workpiece 110 on the table 106.

The image recognizing device 5 image processes the image of the workpiece 110 picked up with the camera 105 to execute the correction position recognizing process (S6) of the drive recognizing system that recognizes the position of the workpiece 110. In the example shown in FIG. 1, the positioning line 112 is set in advance as the stop point of the table 106. At the time of stopping the table 106 when the right end of the workpiece 110 reaches the positioning line 112, the image recognizing device 5 executes the correction position recognizing process (S6) by using the recognition data of the position of the workpiece 110 to measure the correction position.

The correction position measured with the correction position recognizing process (S6) by the image recognizing device 5 is transmitted to the instruction control device 2 via the first data-communication line 8₂ (S7). The instruction control device 2 generates a (k) instruction (S8) as a correction position, in the communication cycle next to the first communication cycle in which the image recognizing device 5 executes the correction position recognizing process (S6). The instruction control device 2 transmits the correction position instruction to the drive control device 3₁ and the drive control device 3₂ via the first data-communication line 8, (S9). The drive control device 3₁ and the drive control device 3₂ simultaneously execute a (k) positioning control (S10a), (S10b) following the correction position instruction, in the communication cycle next to the first communication cycle in which the instruction control device 2 carries out the (k) instruction generation process (S8).

While the pulse generating device 4 is shown separately from the image recognizing device 5 in FIG. 1, the image recognizing device can store the pulse generating function. In this case, to generate the shutter pulse of the camera and the illumination device attached, the feedback position data ( . . . , j₁−1, j₁, j₁+1, . . . ) of the encoder 6₁ and the feedback position data ( . . . , j₂−1, j₂, j₂+1, . . . ) of the encoder 6₂ are transmitted to the image recognizing device having the pulse generating function, and the image recognizing device generates the shutter precision.

As explained above, according to the first embodiment, a machine control device (a drive control device, an auxiliary control device) that constitutes a drive control system is connected and a physical-amount detecting device that detects a physical amount such as position information necessary for the machine control device to operate are connected to each other with a data communication line. Physical amount information detected by the physical-amount detecting device is directly synchronously transmitted to an optional machine control device on the data communication line in a constant cycle. Therefore, communication delay can be decreased, and physical amount information can be transmitted at high speed. Therefore, machine control devices (a drive control device, an auxiliary control device) that constitute a drive control system can cooperate with each other to carry out control synchronously at high speed.

In this case, machine control devices (an instruction control device, a drive control device, an auxiliary control device) are connected to each other by the first data-communication line group that synchronously transmit control information such as position instruction information, in a constant cycle. Each device of the machine control devices (the instruction control device excluded in FIG. 1 can be also included) and the physical-amount detecting device are connected to each other by the second data-communication line group that synchronously transmits physical amount information (position information and the like) detected by the physical-amount detecting device to an optional of the machine control devices other than the instruction control device, in a constant cycle shorter than the communication cycle of the first data-communication line group. Therefore, each machine control device can obtain physical amount information in high frequency, and can improve control precision. In a transmission and receiving system relating to the first data-communication line group, parts for low-cost and low-speed communication can be used. Therefore, cost related to communication can be decreased.

Each of the machine control devices and the physical-amount detecting device can directly exchange control information and physical amount information. Therefore, control information of other machine control device (for example, an image recognizing device, and a pulse generating device) does not need to be communicated via the overall control device, and the load of the overall control device can be decreased.

In addition, because the first data-communication line group and the second data-communication line group transmit data in the numerical data format of a predetermined format, communication errors can be easily processed. Quality degradation of a pulse signal does not occur in the direct transmission of a high-frequency pulse string signal, and noise influence is hardly present either. For example, position information from the encoder is directly transmitted as numerical data, without depending on the rotation number of the servomotor, to the pulse generating device or the image recognizing device, via the second data-communication line group. Therefore, problems of noise can be effectively avoided. Consequently, a transmission distance between devices can be decreased.

### Second Embodiment

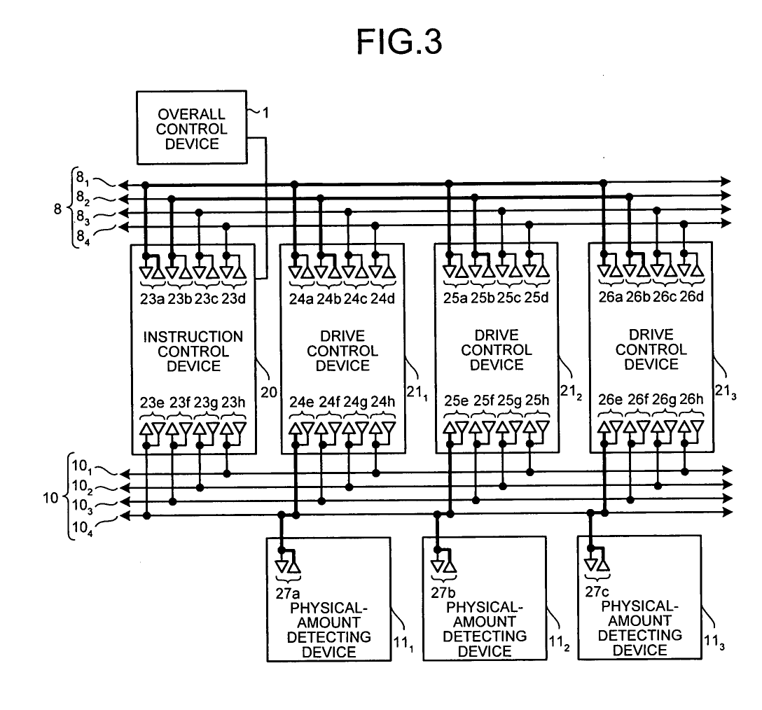

FIG. 3 is a block diagram of a configuration of a drive control system according to a second embodiment of the present invention. In the second embodiment, a detailed example (part one) of a data communication method between the devices explained in the first embodiment is explained. In the first embodiment, it is explained that the instruction control device does not communicate with a physical-amount detecting device. However, the instruction control device communicates with a physical-amount detecting device, depending on characteristics of the drive control system to be constructed. Therefore, in FIG. 3, it is explained that the instruction control device can communicate with the physical-amount detecting device.

In the drive control system shown in FIG. 3, the overall control device 1, an instruction control device 20 and drive control devices 21₁, 21₂, and 21₃ as machine control devices, and physical-amount detecting devices 11₁, 11₂, and 11₃ are shown. The auxiliary control device shown in FIG. 1 is omitted. The physical-amount detecting devices 11₁, 11₂, and 11₃ are position sensors (encoders) and speed sensors.

The overall control device 1 communicates with only the instruction control device 20. The instruction control device 20 communicates with the drive control devices 21₁, 21₂, and 21₃ via the first data-communication line group 8. The first data-communication line group 8 includes four data communication lines 8₁, 8₂, 8₃, and 8₄. In other words, each of the instruction control device 20 and the drive control devices 21₁, 21₂, and 21₃ has a transmitting and receiving unit capable of individually accessing the four data communication lines 8₁, 8₂, 8₃, and 8₄.

In other words, the instruction control device 20 includes a transmitting and receiving unit 23a connected to the first data-communication line 8₁, a transmitting and receiving unit 23b connected to the first data-communication line 8₂, a transmitting and receiving unit 23c connected to the first data-communication line 8₃, and a transmitting and receiving unit 23d connected to the first data-communication line 8₄.

The drive control device 21₁ includes a transmitting and receiving unit 24a connected to the first data-communication line 8₁, a transmitting and receiving unit 24b connected to the first data-communication line 8₂, a transmitting and receiving unit 24c connected to the first data-communication line 8₃, and a transmitting and receiving unit 24d connected to the first data-communication line 8₄.

The drive control device 21₂ includes a transmitting and receiving unit 25a connected to the first data-communication line 8₁, a transmitting and receiving unit 25b connected to the first data-communication line 8₂, a transmitting and receiving unit 25c connected to the first data-communication line 8₃, and a transmitting and receiving unit 25d connected to the first data-communication line 8₄.

The drive control device 21₃ includes a transmitting and receiving unit 26a connected to the first data-communication line 8₁, a transmitting and receiving unit 26b connected to the first data-communication line 8₂, a transmitting and receiving unit 26c connected to the first data-communication line 8₃, and a transmitting and receiving unit 26d connected to the first data-communication line 8₄.

The second data-communication line group 10 includes four data communication lines 10₁, 10₂, 10₃, and 10₄. Each of the instruction control device 20 and the drive control devices 21₁, 21₂, and 21₃ has a transmitting and receiving unit capable of individually accessing the four data communication lines 10₁, 10₂, 10₃, and 10₄.

In other words, the instruction control device 20 includes a transmitting and receiving unit 23e connected to the second data-communication line 10₄, a transmitting and receiving unit 23f connected to the second data-communication line 10₃, a transmitting and receiving unit 23g connected to the second data-communication line 10₂, and a transmitting and receiving unit 23h connected to the second data-communication line 10₁.

The drive control device 21₁ includes a transmitting and receiving unit 24e connected to the second data-communication line 10₄, a transmitting and receiving unit 24f connected to the second data-communication line 10₃, a transmitting and receiving unit 24g connected to the second data-communication line 10₂, and a transmitting and receiving unit 24h connected to the second data-communication line 10₁.

The drive control device 21₂ includes a transmitting and receiving unit 25e connected to the second data-communication line 10₄, a transmitting and receiving unit 25f connected to the second data-communication line 10₃, a transmitting and receiving unit 25g connected to the second data-communication line 10₂, and a transmitting and receiving unit 25h connected to the second data-communication line 10₁.

The drive control device 21₃ includes a transmitting and receiving unit 26e connected to the second data-communication line 10₄, a transmitting and receiving unit 26f connected to the second data-communication line 10₃, a transmitting and receiving unit 26g connected to the second data-communication line 10₂, and a transmitting and receiving unit 26h connected to the second data-communication line 10₁.

On the other hand, each of the physical-amount detecting devices 11₁, 11₂, and 11₃ has one transmitting and receiving unit, and can access one of the four data communication lines 10₁, 10₂, 10₃, and 10₄. Specifically, in FIG. 3, transmitting and receiving units 27a, 27b, and 27c owned by the physical-amount detecting devices 11₁, 11₂, and 11₃ are connected to the second data-communication line 10₄.

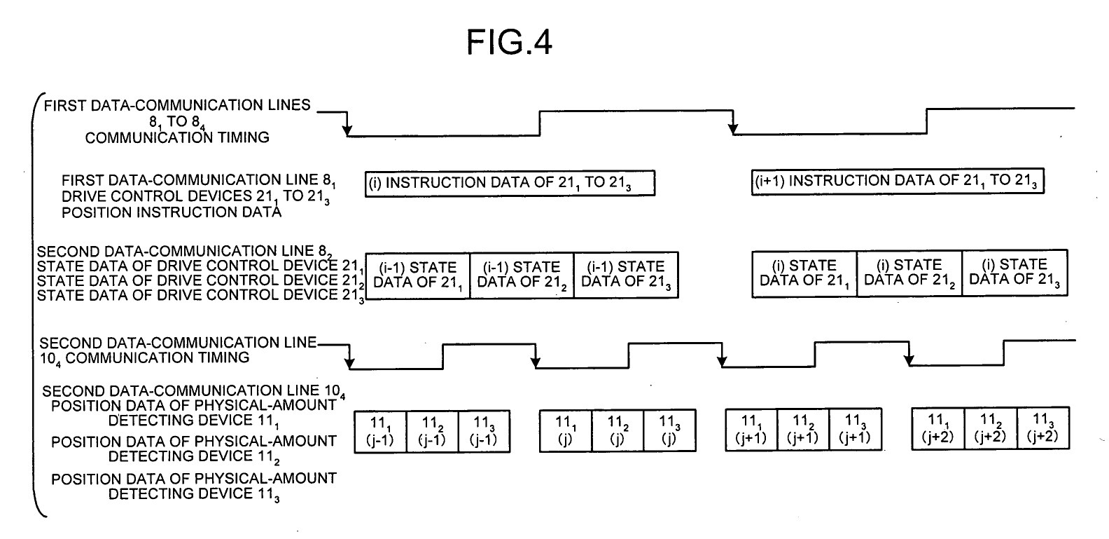

Modes of data communication carried out by the drive control system shown in FIG. 3 are explained with reference to FIG. 3 and FIG. 4. FIG. 4 is a time chart for explaining the operation of communication data exchanges via data communication lines carried out by the machine control device and the physical-amount detecting device shown in FIG. 3.

As shown in FIG. 4, in the drive control system shown in FIG. 3, the instruction control device 20 transmits position instruction data to the drive control devices 21₁, 21₂, and 21₃, using only the first data-communication line 8₁. The drive control devices 21₁, 21₂, and 21₃ also transmit state data to the instruction control device 20, using only the first data-communication line 8₂. The physical-amount detecting devices 11₁, 11₂, and 11₃ transmit detected physical amount information to the drive control devices 21₁, 21₂, and 21₃, using only the second data-communication line 10₄.

In FIG. 4, the instruction control device 20 repeatedly transmits the instruction data to the drive control devices 21₁, 21₂, and 21₃ on the first data-communication line 8₁, in the order of “i-th instruction data”, “(i+1)-th instruction data”, . . . , in each first data communication cycle.

At the same time, the drive control devices 21₁, 21₂, and 21₃ monitor the transmission time of the own device within the first data communication cycle. When the transmission time of the own device comes, the drive control devices 21₁, 21₂, and 21₃ transmit the state data of the own device to the instruction control device 20 via the first data-communication line 8₂, in each first data communication cycle used by the instruction control device 20. As a result, the state data of each drive control device is transmitted in time division within the first data communication cycle. In other words, the “state data of the drive control device 21₁”, the “state data of the drive control device 21₂”, and the “state data of the drive control device 21₃” are repeatedly transmitted as a set, in the order of “i-th instruction data”, “(i+1)-th instruction data”, . . . , in each first data communication cycle used by the instruction control device 20.

On the other hand, the physical-amount detecting devices 11₁, 11₂, and 11₃ monitor the transmission time of the own device within the second data communication cycle, in each second data communication cycle. When the transmission time of the own device comes, the physical-amount detecting devices 11₁, 11₂, and 11₃ transmit the physical amount data (position data in the first embodiment) of the own device to the drive control devices 21₁, 21₂, and 21₃ via the second data-communication line 10₄. As a result, the position data of each physical-amount detecting device is transmitted by time division within the second data communication cycle. In other words, each physical-amount detecting device transmits the “j-th position data” by time division, and then transmits the “(j+1)-th position data” by time division in the next communication cycle, and repeats this process.

As explained above, according to the second embodiment, in FIG. 3, the auxiliary control device is not shown, and each machine control device constituting the drive control system includes a transmitting and receiving unit capable of individually accessing two or more data communication lines constituting the first data-communication line group. Therefore, the optimum first data-communication line can be selected, according to a kind of data communicated, a data amount to be transmitted at one time within the first communication cycle, and a time width of the first communication cycle.

In the second embodiment, as a concrete example (1), the following operation is shown. As shown in FIG. 4, the data amount that the instruction control device can transmit data to plural drive control devices is the amount that can be transmitted at one time within the first communication cycle. Therefore, the instruction control device selects one of the first data-communication lines for transmission to the drive control device from the first data-communication line group, and transmits data to plural drive control devices at one time. Further, because the data amount that the plural drive control devices can transmit to the instruction control device is the amount that can be transmitted at one time within the first communication cycle, the plural drive control devices select one of the first data-communication lines for transmission to the instruction control device from the first data-communication line group, and transmit data to the instruction control device at one time.

Because each machine control device constituting the drive control system includes a transmitting and receiving unit capable of individually accessing one or more second data-communication lines constituting the second data-communication line group that collect physical amount information, plural physical-amount detecting device each, including one transmitting and receiving unit, can select optimum one or more second data-communication lines corresponding to the data amount that can be transmitted at one time within the second communication cycle and the time interval of the second communication cycle.

In the second embodiment, as a concrete example (1), the following operation is shown. As shown in FIG. 4, the data amount that plural physical-amount detecting devices can transmit data is the amount that can be transmitted at one time within the second communication cycle. Therefore, the plural physical-amount detecting devices select one optional common second data-communication line from among one or more second data-communication lines constituting the second data-communication line group, and transmit data to the machine control devices at one time.

Therefore, according to the second embodiment, even when the number of drive control devices increases, a drive control system can be realized in which each device cooperates to control driving at high speed in synchronization.

According to the data communication method of the second embodiment, while the instruction control device transmits position instruction information by exclusively using one data communication line between the instruction control device and plural drive control device, plural drive control devices can transmit state data by sharing one data communication line. Plural physical-amount detecting devices can also transmit physical amount data by sharing one data communication line. Therefore, while the four first data-communication lines are shown in FIG. 3, the number of the first data-communication lines can be two. While the four second data-communication lines are shown in FIG. 3, the number of the second data-communication lines can be also one. In other words, according to the second embodiment, cost increase due to the increase in the number of data communication lines can be suppressed.

### Third Embodiment

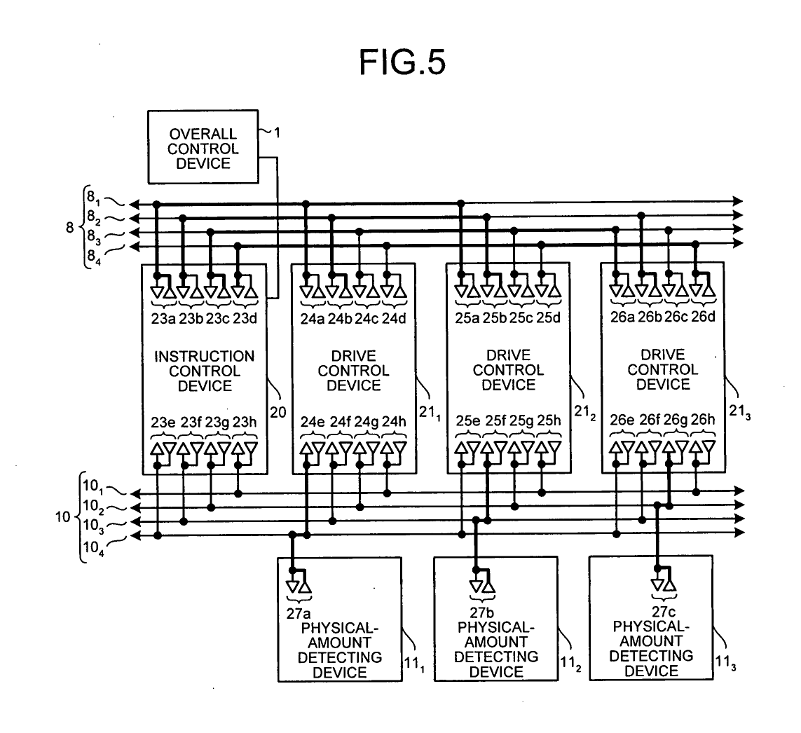

FIG. 5 is a block diagram of a configuration of a drive control system according to a third embodiment of the present invention. In the third embodiment, a detailed example (part two) of a data communication method between the devices explained in the first embodiment is explained. The instruction control device communicates with a physical-amount detecting device, in the same manner to that shown in FIG. 3.

In the drive control system shown in FIG. 5, a connection relationship between the transmitting and receiving units 27a, 27b, 27c included in the physical-amount detecting devices 11₁, 11₂, and 11₃ and the second data-communication line group 10 shown in the drive control system in FIG. 3 is different.

In other words, the transmitting and receiving unit 27a owned by the physical-amount detecting device 11₁ is connected to the second data-communication line 10₄. The transmitting and receiving unit 27b owned by the physical-amount detecting device 11₂ is connected to the second data-communication line 10₃. The transmitting and receiving unit 27c owned by the physical-amount detecting device 11₃ is connected to the second data-communication line 10₂.

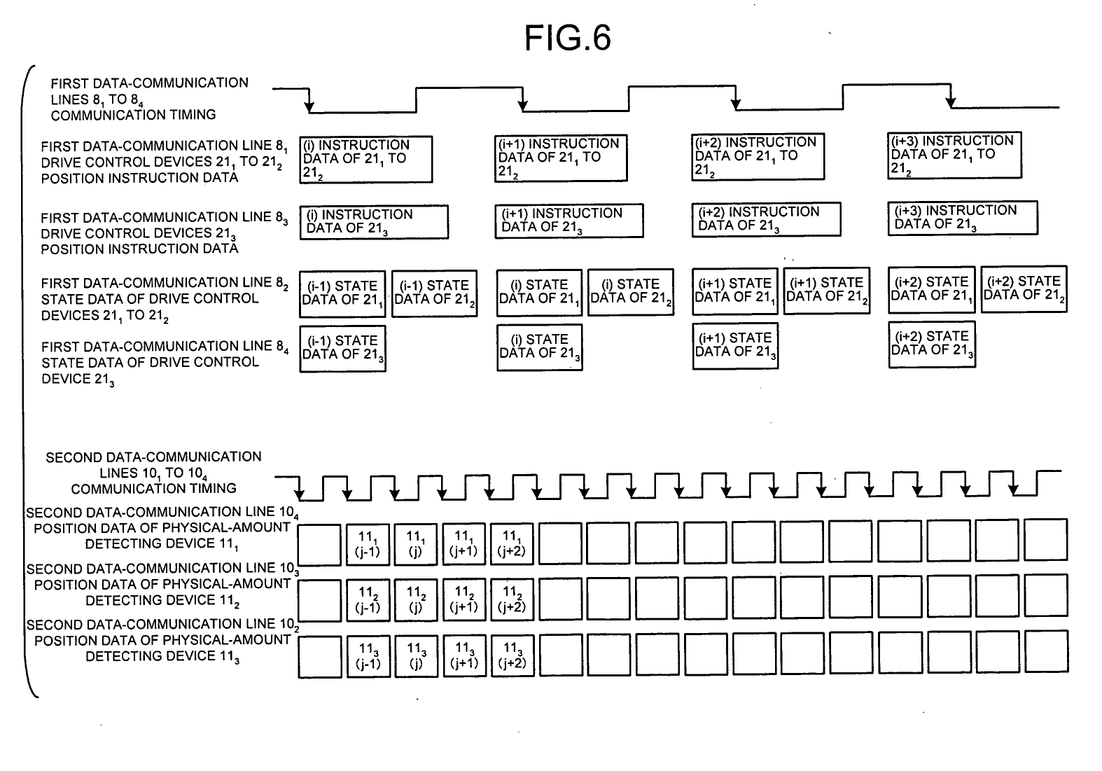

Modes of data communication carried out by the drive control system shown in FIG. 5 are explained with reference to FIG. 5 and FIG. 6. FIG. 6 is a time chart for explaining the operation of communication data exchanges via data communication lines carried out by the machine control device and the physical-amount detecting device shown in FIG. 5.

As shown in FIG. 6, in the drive control system shown in FIG. 5, the instruction control device 20 transmits position instruction data to the drive control devices 21₁ and 21₂, using in common the first data-communication line 8₁. The instruction control device 20 transmits position instruction data to the drive control device 21₃, using the first data-communication line 8₂. The drive control devices 21₁ and 21₂, transmit state data to the instruction control device 20, using in common the first data-communication line 8₂. The drive control device 21₃ transmits state data to the instruction control device 20, using the first data-communication line 8₄.

The physical-amount detecting device 11₁ transmits detected physical amount information to the drive control devices 21₁, 21₂, and 21₃, using the second data-communication line 10₄. The physical-amount detecting device 11₂ transmits detected physical amount information to the drive control devices 21₁, 21₂, and 21₃, using the second data-communication line 10₃. The physical-amount detecting device 11₃ transmits detected physical amount information to the drive control devices 21₁, 21₂, and 21₃, using the second data-communication line 10₂.

In FIG. 6, the instruction control device 20 repeatedly transmits the instruction data to the drive control devices 21₁ and 21₂, on the first data-communication line 8₁, in the order of the “i-th instruction data”, the “(i+1)-th instruction data”, . . . , in each first data communication cycle. At the same time, the instruction control device 20 repeatedly transmits the instruction data to the drive control device 21₃, on the first data-communication line 8₃, in the order of the “i-th instruction data”, the “(i+1)-th instruction data”, . . . , in each first data communication cycle.

At the same time, the drive control devices 21₁, 21₂, monitor the transmission time of the own device in each first data communication cycle. When the transmission time of the own device comes, the drive control devices 21₁ and 21₂, transmit the state data of the own device to the instruction control device 20 via the first data-communication line 8₂, in each first data communication cycle used by the instruction control device 20. As a result, the state data of each drive control device is transmitted in time division within the first data communication cycle. In other words, the “state data of the drive control device 21₁”, and the “state data of the drive control device 21₂” are repeatedly transmitted as a set, in the order of the “i-th instruction data”, the “(i+1)-th instruction data”, . . . , in each first data communication cycle used by the instruction control device 20.

At the same time, the drive control device 21₃ monitors the transmission time of the own device in each first data communication cycle. When the transmission time of the own device comes, the drive control device 21₃ transmits the state data of the own device that is, “i-th state data”, “(i+1)-th state data”, . . . , repeatedly, to the instruction control device 20 via the first data-communication line 8₄, in each first data communication cycle used by the instruction control device 20.

On the other hand, the physical-amount detecting devices 11₁, 11₂, and 11₃ transmit position data to the drive control devices 21₁, 21₂, and 21₃, via the second data-communication line 10₄, in each second data communication cycle. The physical-amount detecting device 11₂ transmits position data to the drive control devices 21₁, 21₂, and 21₃, via the second data-communication line 10₃, and the physical-amount detecting device 11₃ transmits position data to the drive control devices 21₁, 21₂, and 21₃, via the second data-communication line 10₂. In other words, each physical-amount detecting device simultaneously transmits physical amount data (position data) using the three data communication lines in parallel.

As can be understood from FIG. 4 and FIG. 6, the second communication cycle is shorter than the first communication cycle in FIG. 4 and FIG. 6. The second communication cycle in FIG. 6 is shorter than that shown in FIG. 4. In the second-communication cycle shown in FIG. 6, a larger amount of physical amount data can be transmitted in parallel at a higher speed. Consequently, the drive control devices 21₁, 21₂, and 21₃ can collect a larger amount of physical amount data than that collected in the cycle shown in FIG. 4, within the first communication cycle.

In this way, according to the third embodiment, while the auxiliary control device is not shown in FIG. 5, each machine control device constituting the drive control system includes a transmitting and receiving unit capable of individually accessing two or more data communication lines constituting the first data-communication line group. Therefore, the optimum first data-communication line can be selected, according to a kind of data communicated, a data amount to be transmitted at one time within the first communication cycle, and a time width of the first communication cycle.

While this is similar to that of the second embodiment, according to the third embodiment, as a concrete example (2), the following operation is shown. The data amount that the instruction control device can transmit data to plural drive control devices is not the amount that can be transmitted at one time within the first communication cycle. Therefore, the instruction control device selects one of the first data-communication lines for transmission to the drive control device from the first data-communication line group, and transmits data to drive control devices having a large amount of data. On the other hand, the instruction control device selects the other first data-communication line for transmission to the drive control device from the first data-communication line group, and collectively transmits data at one time to a collected group of drive control devices having a small amount of data.

Out of the plural drive control devices, the drive control device having a large data transmission amount selects one first data-communication line for transmission to the instruction control device from the first data-communication line group. The drive control devices having a small data transmission amount select in a group the other first data-communication line for transmission to the instruction control device from the first data-communication line group, and transmit data at one time in time division, to the instruction control device.

Each machine control device constituting the drive control system includes a transmitting and receiving unit capable of individually accessing two or more data communication lines constituting the second data-communication line group for collecting physical amount information. Therefore, the plural physical-amount detecting devices, each including one transmitting and receiving unit, can optimally select one or more second data-communication lines, according to a data amount to be transmitted at one time within the second communication cycle, and a time width of the second communication cycle.

This is similar to that of the second embodiment. According to the third embodiment, as a concrete example (2), the following operation is shown. In FIG. 6, to meet the request to enable plural physical-amount detecting devices to transmit physical amount data in high frequency, the second communication cycle is configured shorter than that shown in FIG. 4. Each of the plural physical-amount detecting devices exclusively selects one of the plural second data-communication lines, and the plural physical-amount detecting devices transmit data at once in parallel.

In this case, in the first data-communication line group and the second data-communication line group, the number of data communication lines increases from that in the second embodiment. However, the machine control device can collect more physical amount data than that according to the second embodiment, within the first communication cycle.

Therefore, according to the third embodiment, even when the number of drive control devices increases, a drive control system can be realized in which each device cooperates to control driving at high speed in synchronization, like in the second embodiment. The drive control can be carried out in high precision.

### Fourth Embodiment

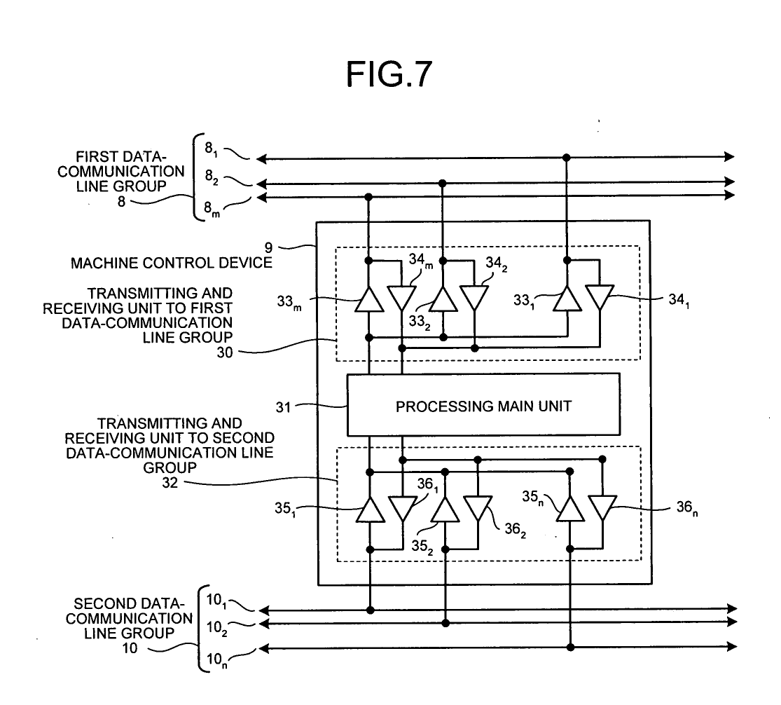

FIG. 7 is a block diagram of a configuration of a machine control device-according to a fourth embodiment of the present invention. The machine control device 9 shown in FIG. 7 includes a transmitting and receiving unit 30 to the first data-communication line group 8, a transmitting and receiving unit 32 to the second data-communication line group 10, and a processing main unit 31 of the machine control device 9 present between both transmitting and receiving units.

The first data-communication line group 8 includes m first data-communication lines 8₁ to 8ₘ, and the second data-communication line group 10 includes n second data-communication lines 10₁ to 10ₙ.

The transmitting and receiving unit 30 for the first data-communication line group 8 includes m transmission buffers 33₁ to 33ₘ, and m receiving buffers 34₁ to 34ₘ for the m first data-communication lines 8₁ to 8ₘ. Input ends of the transmission buffers are collectively connected to one first data-communication line group output port, and output ends of the receiving buffers are collectively connected to one first data-communication line group input port of the processing main unit 31.

The transmitting and receiving unit 32 for the second data-communication line group 10 includes n receiving buffers 35₁ to 35ₙ, and n transmission buffers 36₁ to 36ₙ for the n second data-communication lines 10₁ to 10ₙ. Input ends of the transmission buffers are collectively connected to one second data-communication line group output port, and output ends of the receiving buffers are collectively connected to one second data-communication line group input port of the processing main unit 31.

In the machine control device having the configuration explained above, control information can be transmitted to and received from the first data-communication line group 8, by optionally selecting at least one first data-communication line, by individually conduction controlling the transmission buffers 33₁ to 33ₘ and the receiving buffers 34₁ to 34ₘ of the receiving unit 30. For example, by taking the control information of the first data-communication line 8ₘ into the receiving buffer 34ₘ, the processed control information can be transmitted from the transmission buffer 33₁ to the first data-communication line 8₁.

Control information can be transmitted to and received from the second data-communication line group 10, by optionally selecting at least one second data-communication line, by individually conduction controlling the transmission buffers 36₁ to 36ₙ and the receiving buffers 35₁ to 35ₙ of the receiving unit 32. For example, by taking the control information of the second data-communication line 10ₙ into the receiving buffer 35ₙ, the processed physical amount information can be transmitted from the transmission buffer 36₁ to the second data-communication line 10₁.

In FIG. 7, the processing main unit 31 has a set of transmitting and receiving ports at each of the first data-communication line group side and the second data-communication line group side. Therefore, as described above, simultaneously, control information is exchanged using one communication line of the first data-communication line group, and physical amount is exchanged using one communication line of the second data-communication line group. When plural transmitting and receiving ports are provided at both sides or one side of the first data-communication line group and the second data-communication line group of the processing main unit 31, plural kids of data can be received or transmitted at both sides or one side of the first data-communication line group and the second data-communication line group.

As explained above, according to the fourth embodiment, because a transmitting and receiving unit is provided in each data communication line at both or one of the first data-communication line group and the second data-communication line group, information of plural data communication lines can be simultaneously transmitted and received.

By controlling conduction of the buffer of the transmitting and receiving unit provided in each data communication line at both or one of the first data-communication line group and the second data-communication line group, information of an optional data communication line can be selected and received, and transmitted to other data communication line. Therefore, necessary information can be simultaneously transmitted to each machine control device.

Accordingly, when a drive control system is configured by optimally selecting a data communication line matching a kind of communication information, a communication cycle, and a communication direction, there is an effect of flexibly, efficiently and synchronously transmitting control information and physical amount information necessary for drive control, by suppressing system cost.

In the embodiment explained above, devices exchange signals at high speed via data communication lines in the drive control system including the auxiliary control device. However, the application of the present invention is not limited to this, and can be similarly applied to a drive control system which does not include the auxiliary control device, thereby obtaining similar effects.

The transmitting and receiving unit of the second data-communication line group in the physical-amount detecting device can have a configuration similar to that of the transmitting and receiving unit 32 of the second data-communication line group shown in FIG. 7.

### INDUSTRIAL APPLICABILITY

As described above, the drive control system and the machine control device according to the present invention are suitable for application to various mechatronic products that require drive control of a numerical control device, a robot, a semiconductor manufacturing device, and a mounting device of an electronic device.

1-16. (canceled)

17. A drive control system comprising:
an instruction control device that generates an instruction for drive controlling a motor which controls a drive shaft of an object;
a physical-amount detecting device that detects a physical amount including at least one of position information and speed information of the object as the drive shaft of the motor rotates based on the instruction;
a drive control device that generates a drive control signal for controlling the motor based on the instruction and the physical amount;
an auxiliary control device that generates displacement information of the object, which is required by the instruction control device to generate the instruction, based on the physical amount;
a first data-communication line that connects the instruction control device and the drive control device in parallel, wherein when transmitting or receiving control information through or from the first data-communication line, the instruction control device and the drive control device transmit or receive the control information in a communication data format following a first communication cycle prescribed by the first data-communication line; and
a second data-communication line that connects the physical-amount detecting device and the drive control device in parallel, the second data-communication line having a second communication cycle shorter than the first communication cycle, wherein the physical-amount detecting device converts the physical amount into a communication data format and transmits the communication data to the second data-communication line following the second communication cycle, and the drive control device receives the physical amount data from the second data-communication line following the second communication cycle.

18. The drive control system according to claim 17, wherein number of the first data-communication lines is determined based on at least one of a kind of data communicated by the instruction control device, the drive control device, and the auxiliary control device, a relationship between amount of data transmitted and a time width of the first communication cycle, and a communication direction.

19. The drive control system according to claim 17, wherein number of the second data-communication lines is determined based on a relationship between amount of data transmitted by a plurality of the physical-amount detecting devices and a time width of the second communication cycle.

20. The drive control system according to claim 17, wherein the first data-communication line includes a plurality of first data-communication lines, and
each of the instruction control device, the drive control device, and the auxiliary control device includes a first transmitting/receiving unit capable of accessing the first data-communication lines, and the first transmitting/receiving unit transmits control data received from an arbitrary first data-communication line to another arbitrary first data-communication line.

21. The drive control system according to claim 17, wherein
the second data-communication line includes a plurality of second data-communication lines, and
each of the instruction control device, the drive control device, and the auxiliary control device includes a second transmitting/receiving unit capable of accessing each of the second data-communication lines, and the second transmitting/receiving unit transmits control data received from an arbitrary second data-communication line to another arbitrary second data-communication line.

22. The drive control system according to claim 17, wherein
the second data-communication line includes a plurality of second data-communication lines, and
the physical-amount detecting device includes a transmitting/receiving unit capable of individually accessing the second data-communication lines.

23. A machine control device comprising:
an instruction control device that generates an instruction for drive controlling a motor which controls a drive shaft of an object;
a physical-amount detecting device that detects a physical amount including at least one of position information and speed information of the object as the drive shaft of the motor rotates based on the instruction;
a drive control device that generates a drive control signal for controlling the motor based on the instruction and the physical amount; and
an auxiliary control device that generates displacement information of the object, which is required by the instruction control device to generate the instruction, based on the physical amount, wherein
each of the instruction control device, the physical-amount detecting device, the drive control device, and the auxiliary control device includes a first transmitting/receiving unit that is capable of individually accessing a plurality of data communication lines for transmitting control data, and that receives control data from an arbitrary first data-communication line and transmits received control data to another arbitrary first data-communication line.

24. The machine control device according to claim 23, wherein each of the instruction control device, the physical-amount detecting device, the drive control device, and the auxiliary control device includes a second transmitting/receiving unit that is capable of individually accessing a plurality of second data-communication lines for transmitting physical amount data, the second transmitting/receiving unit receives physical amount data from an arbitrary second data-communication line and transmits received physical amount data to another arbitrary second data-communication line.
